(19) United States
(12) Patent Application Publication
(10) Pub. No.: US 2012/0132362 A1
(43) Pub. Date: May 31, 2012

(54) RESIN-IMPREGNATED SHEET AND METHOD FOR PRODUCING RESIN-IMPREGNATED SHEET LAMINATE WITH METAL FOIL

(75) Inventors: Shohei AZAMI, Tsukuba-shi (JP); Satoshi OKAMOTO, Tsukuba-shi (JP); Hironobu IYAMA, Osaka (JP)

(73) Assignee: SUMITOMO CHEMICAL COMPANY, LIMITED, Tokyo (JP)

(21) Appl. No.: 13/280,408

(22) Filed: Oct. 25, 2011

(30) Foreign Application Priority Data
Nov. 29, 2010 (JP) 2010-264839

(51) Int. Cl. C09K 19/06; B32B 37/02

(52) U.S. Cl. 156/313; 252/299.6

(57) ABSTRACT

A resin-impregnated sheet obtained by impregnating a fiber sheet with a thermoplastic resin, wherein a weight loss rate upon a heat treatment at 225° C. for 30 minutes is from 6.8 to 10% by mass; and a method for producing a resin-impregnated sheet laminate with a metal foil, which comprises preliminarily pressing a plurality of the resin-impregnated sheets while being laid one upon another, subjecting the obtained resin-impregnated sheet laminate to a heat treatment, and arranging a metal foil on both sides of the sheet laminate, followed by regular pressing.

### BACKGROUND OF THE INVENTION

(1) Field of the Invention

The present invention relates to a resin-impregnated sheet obtained by impregnating a fiber sheet with a thermoplastic resin, and a method for producing a resin-impregnated sheet laminate with a metal foil, using this resin-impregnated sheet.

(2) Description of Related Art

It has been studied to use, as an insulating layer of a printed circuit board, a resin-impregnated sheet obtained by impregnating a fiber sheet with a thermoplastic resin. For example, JP-A-2007-146139 and JP-A-2010-80479 disclose that a resin-impregnated sheet laminate with a metal foil for a printed circuit board is obtained by subjecting the resin-impregnated sheet to a heat treatment, laying a plurality of the resin-impregnated sheets one upon another, and arranging a metal foil on both sides of the resin-impregnated sheets, followed by pressing.

The resin-impregnated sheet laminate with a metal foil disclosed in JP-A-2007-146139 and JP-A-2010-80479 has a problem that it has not necessarily sufficient tight adhesion between the resin-impregnated sheets and peeling is likely to occur between the resin-impregnated sheets and thus blister is likely to occur on a surface of a resin-impregnated sheet laminate when exposed to high temperature after exposure to high humidity.

The present inventors have intensively studied so as to solve the above problems and found that tight adhesion between the resin-impregnated sheets is improved and peeling is less likely to occur between the resin-impregnated sheets by preliminarily pressing a plurality of resin-impregnated sheets each obtained by impregnating a fiber sheet with a thermoplastic resin while being laid one upon another, subjecting the obtained resin-impregnated sheet laminate to a heat treatment, and arranging a metal foil on both sides of the sheet laminate, followed by regular pressing. In that case, they have found that tight adhesion between the resin-impregnated sheets is further improved and peeling is still less likely to occur between the resin-impregnated sheets when the temperature of preliminary pressing is increased. In contrast, they encountered a problem that the thermoplastic resin is likely to deteriorate and thus peeling is likely to occur between the thermoplastic resin and the fiber sheet.

### SUMMARY OF THE INVENTION

Thus, an object of the present invention is to provide a resin-impregnated sheet which gives a resin-impregnated sheet laminate with a metal foil having excellent tight adhesion between resin-impregnated sheets even when the temperature of preliminary pressing is low.

In order to achieve the above object, the present invention provides a resin-impregnated sheet obtained by impregnating a fiber sheet with a thermoplastic resin, wherein a weight loss rate upon a heat treatment at 225° C. for 30 minutes is from 6.8 to 10% by mass. According to the present invention, there is also provided a method for producing a resin-impregnated sheet laminate with a metal foil, which includes preliminarily pressing a plurality of the above resin-impregnated sheets while being laid one upon another, subjecting the obtained resin-impregnated sheet laminate to a heat treatment, and arranging a metal foil on both sides of the sheet laminate, followed by regular pressing.

It is possible to obtain a resin-impregnated sheet laminate with a metal foil, which is excellent in tight adhesion between resin-impregnated sheets, by using the resin-impregnated sheet of the present invention.

### DETAILED DESCRIPTION OF PREFERRED EMBODIMENTS

The resin-impregnated sheet of the present invention is obtained by impregnating a fiber sheet with a thermoplastic resin, and is preferably obtained by impregnating a fiber sheet with a liquid composition containing a thermoplastic resin and a solvent, and then removing the solvent.

Examples of the thermoplastic resin include polypropylene, polyamide, polyester, polyphenylene sulfide, polyetherketone, polycarbonate, polyethersulfone, polyphenyleneether and polyetherimide. Among these thermoplastic resins, a liquid crystal polyester is preferably used since it has high heat resistance and low dielectric loss.

A liquid crystal polyester is preferably a liquid crystal polyester which exhibits mesomorphism in a molten state, and is melted at a temperature of 450° C. or lower. The liquid crystal polyester may be a liquid crystal polyesteramide, a liquid crystal polyester ether, a liquid crystal polyester carbonate, or a liquid crystal polyesterimide. The liquid crystal polyester is preferably a whole aromatic liquid crystal polyester which is prepared by using only an aromatic compound as a raw monomer.

Typical examples of the liquid crystal polyester include a liquid crystal polyester obtained by polymerizing (polycondensing) an aromatic hydroxycarboxylic acid, an aromatic dicarboxylic acid, and at least one kind of compound selected from the group consisting of an aromatic diol, an aromatic hydroxyamine and an aromatic diamine; a liquid crystal polyester obtained by polymerizing plural kinds of aromatic hydroxycarboxylic acids; a liquid crystal polyester obtained by polymerizing an aromatic dicarboxylic acid, and at least one kind of compound selected from the group consisting of an aromatic diol, an aromatic hydroxyamine and an aromatic diamine; and a liquid crystal polyester obtained by polymerizing a polyester such as polyethylene terephthalate, and an aromatic hydroxycarboxylic acid. Herein, in place of a part or all of the aromatic hydroxycarboxylic acid, the aromatic dicarboxylic acid, the aromatic diol, the aromatic hydroxyamine and the aromatic diamine, each independently, polymerizable derivative thereof may be used.

Examples of the polymerizable derivative of a compound having a carboxyl group, such as an aromatic hydroxycarboxylic acid or an aromatic dicarboxylic acid include a polymerizable derivative (ester) in which the carboxyl group has been converted into an alkoxycarbonyl group or an aryloxycarbonyl group, a polymerizable derivative (acid halide) in which the carboxyl group has been converted into a haloformyl group, and a polymerizable derivative (acid anhydride) in which the carboxyl group has been converted into an acyloxycarbonyl group. Examples of the polymerizable derivative of a compound having a hydroxyl group, such as an aromatic hydroxycarboxylic acid, an aromatic diol or an aromatic hydroxylamine include a polymerizable derivative (acylate) in which the hydroxyl group has been converted into an acyloxyl group through acylation. Examples of the polymerizable derivative of a compound having an amino group, such as an aromatic hydroxyamine or an aromatic diamine include a polymerizable derivative (acylate) in which the amino group has been converted into an acylamino group through acylation.

The liquid crystal polyester preferably includes a repeating unit represented by the following formula (1) (hereinafter may be sometimes referred to as a “repeating unit (1)”), and more preferably includes the repeating unit (1), a repeating unit represented by the following formula (2) (hereinafter may be sometimes referred to as a “repeating unit (2)”) and a repeating unit represented by the following formula (3) (hereinafter may be sometimes referred to as a “repeating unit (3)”).

—O—Ar¹—CO—, (1)

—CO—Ar²—CO—, (2)

—X—Ar³—Y—, (3)

wherein Ar¹ represents a phenylene group, a naphthylene group or a biphenylylene group, Ar² and Ar³ each independently represents a phenylene group, a naphthylene group, a biphenylylene group, or a group represented by the following formula (4), X and Y each independently represents an oxygen atom or an imino group (—NH—) and hydrogen atoms existing in the group represented by Ar¹, Ar² or Ar³ each independently may be substituted with a halogen atom, an alkyl group or an aryl group, and

—Ar⁴—Z—Ar⁵— (4)

wherein Ar⁴ and Ar⁵ each independently represents phenylene group or a naphthylene group, and Z represents an oxygen atom, a sulfur atom, a carbonyl group, a sulfonyl group or an alkylidene group.

Examples of the halogen atom include a fluorine atom, a chlorine atom, a bromine atom and an iodine atom. Examples of the alkyl group include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group and an n-decyl group, and the number of carbon atoms is usually from 1 to 10. Examples of the aryl group include a phenyl group, an o-tolyl group, a m-tolyl group, a p-tolyl group, a 1-naphthyl group and a 2-naphthyl group, and the number of carbon atoms is usually from 6 to 20. When the hydrogen atom is substituted with these groups, the number, each independently, is usually 2 or less, and preferably 1 or less, every group represented by Ar¹, Ar² or Ar³.

Examples of the alkylidene group include a methylene group, an ethylidene group, an isopropylidene group, an n-butylidene group and a 2-ethylhexylidene group, and the number of carbon atoms is usually from 1 to 10.

The repeating unit (1) is a repeating unit derived from a predetermined aromatic hydroxycarboxylic acid. The repeating unit (1) is preferably a repeating unit in which Ar¹ is a p-phenylene group (repeating unit derived from p-hydroxybenzoic acid), or a repeating unit in which Ar¹ is a 2,6-naphthylene group (repeating unit derived from 6-hydroxy-2-naphthoic acid).

The repeating unit (2) is a repeating unit derived from a predetermined aromatic dicarboxylic acid. The repeating unit (2) is preferably a repeating unit in which Ar² is a p-phenylene group (repeating unit derived from terephthalic acid), a repeating unit in which Ar² is a m-phenylene group (repeating unit derived from isophthalic acid), a repeating unit in which Ar² is a 2,6-naphthylene group (repeating unit derived from 2,6-naphthalenedicarboxylic acid) or a repeating unit in which Ar² is a diphenylether-4,4′-diyl group (repeating unit derived from diphenylether-4,4′-dicarboxylic acid).

The repeating unit (3) is a repeating unit derived from a predetermined aromatic diol, aromatic hydroxyl amine or aromatic diamine. The repeating unit (3) is preferably a repeating unit in which Ar³ is a p-phenylene group (repeating unit derived from hydroquinone, p-aminophenol or p-phenylenediamine) or a repeating unit in which Ar³ is a 4,4′-biphenylylene group (repeating unit derived from 4,4′-dihydroxybiphenyl, 4-amino-4′-hydroxybiphenyl or 4,4′-diaminobiphenyl).

The content of the repeating unit (1) is usually 30 mol % or more, preferably from 30 to 80 mol %, more preferably from 30 to 60 mol %, and still more preferably from 30 to 40 mol %, based on the total amount of all repeating units (the value of the total amount (mol) equivalent to the amount of substance of each repeating unit determined by dividing mass of each repeating unit constituting a liquid crystal polyester by formula weight of each repeating unit). The content of the repeating unit (2) is usually 35 mol % or less, preferably from 10 to 35 mol %, more preferably from 20 to 35 mol %, and still more preferably from 30 to 35 mol %, based on the total amount of all repeating units. The content of the repeating unit (3) is usually 35 mol % or less, preferably from 10 to 35 mol %, more preferably from 20 to 35 mol %, and still more preferably from 30 to 35 mol %%, based on the total amount of all repeating units. As the content of the repeating unit (1) increases, heat resistance, strength and rigidity are improved more easily. However, when the content is too high, solubility in a solvent is likely to decrease.

A ratio of the content of the repeating unit (2) to that of the repeating unit (3) is usually from 0.9/1 to 1/0.9, preferably from 0.95/1 to 1/0.95, and more preferably from 0.98/1 to 1/0.98, expressed in terms of [content of repeating unit (2)]/[content of repeating unit (3)] (mol/mol).

The liquid crystal polyester may each independently include two or more kinds of repeating units (1) to (3). The liquid crystal polyester may include a repeating unit other than repeating units (1) to (3), and the content is usually 10 mol % or less, and preferably 5 mol % or less, based on the total amount of all repeating units.

The liquid crystal polyester preferably includes, as the repeating unit (3), a repeating unit in which X and/or Y is/are imino group(s), that is, a repeating unit derived from a predetermined aromatic hydroxyl amine and/or a repeating unit derived from an aromatic diamine since solubility in a solvent is excellent, and more preferably includes, as the repeating unit (3), only a repeating unit in which X and/or Y is/are imino group(s).

It is preferred that the liquid crystal polyester is produced by melt polymerization of a raw monomer corresponding to a repeating unit constituting the liquid crystal polyester, followed by solid phase polymerization of the obtained polymer (prepolymer). Whereby, a high-molecular weight liquid crystal polyester having high heat resistance as well as high strength and rigidity can be produced with satisfactory operability. The melt polymerization may be performed in the presence of a catalyst, and examples of the catalyst include metal compounds such as magnesium acetate, stannous acetate, tetrabutyl titanate, lead acetate, sodium acetate, potassium acetate and antimony trioxide; and nitrogen-containing heterocyclic compounds such as 4-(dimethylamino)pyridine and 1-methylimidazole. Among these catalysts, nitrogen-containing heterocyclic compounds are preferably used.

The flow initiation temperature of the liquid crystal polyester is usually 250° C. or higher, preferably from 250 to 350° C., and more preferably from 260 to 330° C. As the flow initiation temperature becomes higher, heat resistance as well as strength and rigidity are improved more easily. However, when the flow initiation temperature is too high, solubility in a solvent is likely to decrease and viscosity of the liquid composition is likely to increase.

The flow initiation temperature is also called a flow temperature, and is the temperature which exhibits a melt viscosity of 4,800 Pas (48,000 poise) when a liquid crystal polyester is melted while heating at a rate of 4° C./minute, and extruded through a nozzle measuring 1 mm in inner diameter and 10 mm in length under a load of 9.8 MPa (100 kg/cm²) using a capillary rheometer, and the flow initiation temperature serves as an indicator of the molecular weight of the liquid crystal polyester (see, for example, edited by Naoyuki Koide, “Liquid Crystal Polymer—Synthesis, Molding and Application”, pp. 95, CMC Publishing CO., LTD., issued on Jun. 5, 1987).

It is possible to use, as the solvent, a solvent in which the thermoplastic resin can be dissolved, specifically a solvent in which the liquid crystal polyester can be dissolved in the concentration ([mass of thermoplastic resin]/[mass of thermoplastic resin]+[mass of solvent]) of 1% by mass or more at 50° C., by appropriate selection.

Examples of the solvent include halogenated hydrocarbons such as dichloromethane, chloroform, 1,2-dichloroethane, 1,1,2,2-tetrachloroethane and o-dichlorobenzene; halogenated phenols such as p-chlorophenol, pentachlorophenol and pentafluorophenol; ethers such as diethylether, tetrahydrofuran and 1,4-dioxane; ketones such as acetone and cyclohexanone; esters such as ethyl acetate and γ-butyrolactone; carbonates such as ethylene carbonate and propylene carbonate; amines such as triethylamine; nitrogen-containing heterocyclic aromatic compounds such as pyridine; nitriles such as acetonitrile and succinonitrile; amides such as N,N-dimethylformamide, N,N-dimethylacetamide and N-methylpyrrolidone; urea compounds such as tetramethylurea; nitro compounds such as nitromethane and nitrobenzene; sulfur compounds such as dimethyl sulfoxide and sulfolane; and phosphorus compounds such as hexamethylphosphoric acid amide and tri-n-butylphosphoric acid, and two or more kinds of these solvents may be used.

The solvent is preferably an aprotic compound since it has low corrosiveness and is easily handled, and particularly preferably a solvent containing an aprotic compound having no halogen atom as a main component. The aprotic compound preferably accounts for 50 to 100% by mass, more preferably 70 to 100% by mass, and still more preferably 90 to 100% by mass, of the entire solvent. It is preferred to use, as the aprotic compound, amides such as N,N-dimethylformamide, N,N-dimethylacetamide and N-methylpyrrolidone since they easily dissolve the thermoplastic resin.

The solvent is also preferably a solvent containing a compound having a dipole moment of 3 to 5 as a main component since it easily dissolves the thermoplastic resin. The compound having a dipole moment of 3 to 5 preferably accounts for 50 to 100% by mass, more preferably 70 to 100% by mass, and still more preferably 90 to 100% by mass, of the entire solvent. It is preferred to use, as the aprotic compound, a compound having a dipole moment of 3 to 5.

The solvent is also preferably a solvent containing a compound having a boiling point of 220° C. or lower under 1 atm as a main component since it is easily removed. The compound having a boiling point of 220° C. or lower under 1 atm preferably accounts for 50 to 100% by mass, more preferably 70 to 100% by mass, and still more preferably 90 to 100% by mass, of the entire solvent. It is preferred to use, as the aprotic compound, a compound having a boiling point of 220° C. or lower under 1 atm.

The content of the thermoplastic resin in the liquid composition is usually from 5 to 60% by mass, preferably from 10 to 50% by mass, and more preferably from 15 to 45% by mass, based on the total amount of the thermoplastic resin and the solvent. The content is appropriately adjusted so that a liquid composition having a desired viscosity is obtained and also a fiber sheet is impregnated with a desired amount of a thermoplastic resin.

The liquid composition may contain a filler. When the liquid composition contain the filler, it is possible to obtain a resin-impregnated sheet which contains the filler and has performances such as low thermal expansion, thermal conductivity, dielectricity and conductivity imparted according to the kind. Also, since a resin-impregnated sheet laminate with a metal foil obtained by using a resin-impregnated sheet containing the filler tends to be inferior in tight adhesion between resin-impregnated sheets as compared with a resin-impregnated sheet laminate with a metal foil obtained by using a resin-impregnated sheet containing no filler, the present invention is particularly effective to the resin-impregnated sheet containing the filler.

Examples of the filler include inorganic fillers such as silica, alumina, titanium oxide, barium titanate, strontium titanate, aluminum hydroxide and calcium carbonate; and organic fillers such as a cured epoxy resin, a crosslinked benzoguanamine resin and a crosslinked acrylic resin; and two or more kinds of these fillers may be used. The content of the filler is usually from 1 to 50% by volume, and preferably from 5 to 30% by volume, based on the thermoplastic resin, and is appropriately adjusted so as to obtain a resin-impregnated sheet having desired performances.

The liquid composition may also contain an additive. Examples of the additive include a leveling agent, a defoamer, an antioxidant, an ultraviolet absorber, a flame retardant and a coloring agent, and the content is usually from 0 to 5 parts by mass based on 100 parts by mass of the thermoplastic resin.

The liquid composition can be prepared by mixing a thermoplastic resin, a solvent and the other compound used optionally, collectively or in the proper order. When a filler is used as the other component, it is preferred that a liquid composition is prepared by dissolving a thermoplastic resin in a solvent to obtain a thermoplastic resin solution, and dispersing a filler in this thermoplastic resin solution.

It is possible to obtain a resin-impregnated sheet by impregnating a fiber sheet with the thus obtained liquid composition, and then removing the solvent from the liquid composition.

Examples of the fiber constituting the fiber sheet include inorganic fibers such as a glass fiber, a carbon fiber and a ceramics fiber; and organic fibers such as a liquid crystal polyester fiber, the other polyester fiber, an aramid fiber and a polybenzazole fiber; and two or more kinds of these fibers may be used. Among these fibers, a glass fiber is preferred. Examples of the glass fiber include an alkali-containing glass fiber, an alkali free glass fiber and a low dielectric glass fiber.

The fiber sheet may be a textile (woven fabric), a knit fabric or a nonwoven fabric, and is preferably a textile since dimensional stability of the resin-impregnated fiber sheet is easily improved. Examples of the weaving method of the textile include plain weave, satin weave, twill weave and mat weave. The weave density of the textile is usually from 10 to 100 fibers/25 mm.

The thickness of the fiber sheet is usually from 10 to 200 μm, and preferably from 10 to 180 μm. Mass per unit area of the fiber sheet is usually from 10 to 300 g/m². The fiber sheet is preferably subjected to a surface treatment using a coupling agent such as a silane coupling agent so as to improve tight adhesion with a resin.

The impregnation of a liquid composition into a fiber sheet is typically performed by immersing a fiber sheet in an immersion tank in which a liquid composition is charged. Herein, it is possible to adjust the amount of the thermoplastic resin to be adhered to the fiber sheet by appropriately adjusting the time of immersion of the fiber sheet and the rate of pulling up the fiber sheet impregnated with the liquid composition from the immersion tank according to the content of the thermoplastic resin in the liquid composition. The adhesion amount of this thermoplastic resin is preferably from 30 to 80% by mass, and more preferably from 40 to 70% by mass, based on the entire mass of the obtained resin-impregnated sheet.

Then, the solvent in the liquid composition is removed from the fiber sheet impregnated with the liquid composition, thereby making it possible to obtain a resin-impregnated sheet. Removal of the solvent is preferably performed by evaporation of the solvent since the operation is simple. Examples of the removal method include heating, decompression and ventilation, and these methods may be used in combination.

In the present invention, when the resin-impregnated sheet is subjected to a heat treatment at 225° C. for 30 minutes, the weight loss rate ((mass of resin-impregnated sheet before heat treatment]−[mass of resin-impregnated sheet after heat treatment])/[mass of resin-impregnated sheet before heat treatment]) is adjusted within a range from 6.8 to 10% by mass. It is possible to obtain a resin-impregnated sheet laminate with a metal foil, which is excellent in tight adhesion between resin-impregnated sheets, by using such a specific resin-impregnated sheet. Specifically, even when the temperature of preliminary pressing is low, a resin-impregnated sheet laminate with a metal foil, which is excellent in tight adhesion between resin-impregnated sheets, can be obtained by preliminarily pressing a plurality of such a specific resin-impregnated sheets while being laid one upon another, subjecting the obtained resin-impregnated sheet laminate to a heat treatment, and arranging a metal foil on both sides of the sheet laminate, followed by regular pressing.

When the weight loss rate is small, it becomes necessary to increase the temperature upon preliminary pressing so as to increase tight adhesion between resin-impregnated sheets. Due to this high temperature, the thermoplastic resin is likely to deteriorate and thus peeling is likely to occur between the thermoplastic resin and the fiber sheet. In contrast, when the weight loss rate is large, the resin-impregnated sheets are likely to stick with each other and thus it becomes difficult to handle.

The weight loss rate serves as an indicator of a volatile component and, when a resin-impregnated sheet is obtained by impregnating a fiber sheet with a liquid composition containing a thermoplastic resin and a solvent, and then removing the solvent, the weight loss rate serves as an indicator of the amount of the residual solvent in the resin-impregnated sheet. Therefore, it is possible to obtain a resin-impregnated sheet, which exhibits the specific weight loss rate, by adjusting the conditions such as temperature, pressure and time upon removal of the solvent thereby adjusting the amount of the solvent to be removed, and adjusting the amount of the residual solvent in the resin-impregnated sheet.

It is possible to obtain a resin-impregnated sheet laminate with a metal foil, which is excellent in tight adhesion between resin-impregnated sheets, by preliminarily pressing a plurality of the thus obtained resin-impregnated sheet of the present invention while being laid one upon another, subjecting the obtained resin-impregnated sheet laminate to a heat treatment, and arranging a metal foil on both sides of the sheet laminate, followed by regular pressing.

It is preferred that preliminary pressing is usually performed in a state where 2 to 10 resin-impregnated sheets are laid one upon another, and a mold release film, a metal sheet and a cushioning material are laid on both sides of the sheets in this order, by heating and pressing from both sides of the sheets using a pair of heating platens of a press. t is also possible to simultaneously obtain a plurality of resin-impregnated sheet laminates in a state where a plurality of sets, which are obtained by laying a mold release film on both sides of those obtained by laying resin-impregnated sheets one upon another, are laid one upon another via a metal sheet, and a metal sheet and a cushioning material are laid on both sides of the sets in this order, by heating and pressing from both sides of the sheets using a pair of heating platens of a press.

Examples of the mold release film include a polyimide film, a polyetherimide film, a polysulfone film and a polyethersulfone film. Examples of the metal sheet include a SUS sheet and an aluminum sheet. Examples of the cushioning material include inorganic fiber nonwoven fabric cushions such as an aramid cushion, a carbon cushion, an alumina fiber nonwoven fabric cushion and others.

The temperature of preliminary pressing is appropriately adjusted according to the kind of the thermoplastic resin, and is usually from 100 to 200° C. As the temperature of preliminary pressing becomes lower, the thermoplastic resin is less likely to deteriorate. However, it becomes difficult to improve tight adhesion between resin-impregnated sheets, and thus the present invention is particularly effective when the temperature of preliminary pressing is low. The pressure of preliminary pressing is usually from 1 to 30 Mpa and the time of preliminary pressing is usually from 10 minutes to 30 hours. It is preferred that preliminary pressing is performed under reduced pressure after reducing the pressure in a press to preferably 2 kPa or less.

The resin-impregnated sheet laminate thus obtained by preliminarily pressing is subjected to a heat treatment. The temperature of the heat treatment is usually from 240 to 330° C., and preferably from 260 to 320° C., and the time of the heat treatment is usually from 1 to 30 hours, and preferably from 1 to 10 hours. It is preferred that the heat treatment is performed under an atmosphere of an inert gas such as a nitrogen gas.

The resin-impregnated sheet laminate thus subjecting to the heat treatment are subjected to regular pressing after laying a metal foil on both sides of the sheet laminate. It is preferred that the resin-impregnated sheet laminate is subjected to regular pressing in a state where a metal foil, a metal sheet and a cushioning material are laid on both sides of the sheet laminate in this order, by heating and pressing from both sides of the sheet laminate using a pair of heating platens of a press. It is also possible to simultaneously obtain a plurality of resin-impregnated sheet laminates in a state where a plurality of sets, which are obtained by laying a metal foil on both sides of a resin-impregnated sheet, are laid one upon another via a metal sheet, and a metal sheet and a cushioning material are laid on both sides of the sets in this order, by heating and pressing from both sides of the sheets using a pair of heating platens of a press.

A copper foil is usually used as the metal foil. Examples of the metal sheet include a SUS sheet and an aluminum sheet. Examples of the cushioning material include inorganic fiber nonwoven fabric cushions such as an aramid cushion, a carbon cushion, an alumina fiber nonwoven fabric cushion and others.

It is possible to obtain a printed circuit board, which is excellent in tight adhesion between resin-impregnated sheets as insulating layers, by forming a predetermined wiring pattern on a metal foil of the thus obtained resin-impregnated sheet laminate with a metal foil.

### EXAMPLES

### [Measurement of Flow Initiation Temperature of Liquid Crystal Polyester]

Using Flow Tester (“Model CFT-500”, manufactured by Shimadzu Corporation), about 2 g of a liquid crystal polyester was filled into a cylinder attached with a die including a nozzle measuring 1 mm in inner diameter and 10 mm in length, and the liquid crystal polyester was melted while raising the temperature at a rate of 4° C./minute under a load of 9.8 MPa (100 kg/cm²) and extruded through the nozzle, and then the temperature at which the viscosity is 4,800 Pa·s (48,000 poise) was measured.

### [Measurement of Weight Loss Ratio of Resin-Impregnated Sheet]

Test pieces each measuring 10 cm×10 cm were cut out from a resin-impregnated sheet and subjected to a heat treatment at 225° C. for 30 minutes, and then a weight loss rate was determined from mass of the resin-impregnated sheet before and after the heat treatment by the following equation.

Weight loss rate (% by mass)−([mass (g) of resin-impregnated sheet before heat treatment]−[mass (g) of resin-impregnated sheet after heat treatment])/[mass (g) of resin-impregnated sheet before heat treatment]×100

[Evaluation of Soldering Heat Resistance after Moisture Absorption of Resin-Impregnated Sheet Laminate with Metal Foil]

A metal foil of a resin-impregnated sheet laminate with a metal foil was removed by etching and test pieces each measuring 50 mm×50 mm were cut out from the remaining resin-impregnated sheet laminate. Nine test pieces were left to stand in a constant temperature bath at 121° C. under 2 atm at a relative humidity of 100% for 2 hours and then immersed in a solder bath at 260° C. for 30 seconds. Nine test pieces after immersing in the solder bath were visually observed, and the presence or absence of peeling (delamination) between the resin-impregnated sheets and peeling (measling) between the resin and the fiber sheet was confirmed.

### Examples 1 to 3, Comparative Examples 1 to 3

### [Production of Liquid Crystal Polyester]

In a reactor equipped with a stirrer, a torque meter, a nitrogen gas introducing tube, a thermometer and a reflux condenser, 1,976 g (10.5 mol) of 6-hydroxy-2-naphthoic acid, 1,474 g (9.75 mol) of 4-hydroxyacetoanilide, 1,620 g (9.75 mol) of isophthalic acid and 2,374 g (23.25 mol) of acetic anhydride were charged. After replacing the gas in the reactor by a nitrogen gas, the temperature was raised from room temperature to 150° C. over 15 minutes under a nitrogen gas flow while stirring and the mixture was refluxed at 150° C. for 3 hours. Then, the temperature was raised from 150° C. to 300° C. over 2 hours and 50 minutes while distilling off the by-produced acetic acid and unreacted acetic anhydride. After maintaining at 300° C. for 1 hour, contents were taken out from the reactor and cooled to room temperature. The obtained solid matter was crushed by a crusher to obtain a powdered prepolymer. A flow initiation temperature of the prepolymer was 235° C. Then, this prepolymer was heated from room temperature to 223° C. under a nitrogen gas atmosphere over 6 hours, subjected to solid phase polymerization by maintaining at 223° C. for 3 hours and then cooled to obtain a powdered liquid crystal polyester. A flow initiation temperature of this liquid crystal polyester was 270° C.

### [Preparation of Liquid Composition]

A liquid crystal polyester (2,200 g) was added to N,N-dimethylacetamide (7,800 g) and the mixture was heated at 100° C. for 2 hours to obtain a liquid crystal polyester solution. Spherical silica (TATSUMORI LTD.) was dispersed in this liquid crystal polyester solution in the proportion of 20% by volume based on the liquid crystal polyester to obtain a liquid composition.

### [Surface Treatment of Glass Cloth]

To 594 g of pure water, 0.5 g of acetic acid and 6 g of 3-methacryloyloxypropylmethyldimethoxysilane (“KBM-502”, manufactured by Shin-Etsu Chemical Co., Ltd.) were added, followed by stirring (at 200 rpm) at room temperature for 30 minutes to obtain a silane compound solution. A T glass cloth (IPC Name: 1078, manufactured by Nitto Boseki Co., Ltd.) was immersed in this silane compound solution at room temperature for 30 minutes and then dried at 100° C. for 10 minutes using a ventilation dryer to obtain a surface treated glass cloth.

### [Production of Resin-Impregnated Sheet]

A surface-treated glass cloth was immersed in a liquid composition at room temperature for 1 minute and then dried at the temperature shown in Table 1 for the time shown in Table 1 using a dryer thereby evaporating the solvent to obtain a resin-impregnated sheet. A weight loss rate of this resin-impregnated sheet is shown in Table 1.

### [Production of Resin-Impregnated Sheet Laminate]

On an aramid cushioning material (thickness of 3 mm, manufactured by Ichikawa Techno-Fabrics Co., Ltd.), a SUS304 sheet (thickness of 5 mm), polyimide film (manufactured by JUNSEI CHEMICAL CO., LTD., thickness 50 μm), four resin-impregnated sheets, a polyimide film (thickness of 50 μm, manufactured by Du Pont-Toray Co., Ltd.), a SUS304 sheet (thickness of 5 mm) and an aramid cushioning material (thickness of 3 mm, manufactured by Ichikawa Techno-Fabrics Co., Ltd.) were laid in this order, followed by preliminary pressing at the temperature shown in Table 1 for the time shown in Table 1 under 5 MPa using a high temperature vacuum press (“KVHC-PRESS” measuring 300 mm in length and 300 mm in width, manufactured by KITAGAWA SEIKI CO., LTD.) to obtain a resin-impregnated sheet laminate composed of four resin-impregnated sheets. In Comparative Example 3, the resin-impregnated sheets were stuck with each other during storage (in a vacuum pack) before use, and thus a resin-impregnated sheet laminate could not be produced.

### [Heat Treatment of Resin-Impregnated Sheet Laminate]

A resin-impregnated sheet laminate was subjected to a heat treatment under a nitrogen gas atmosphere at 290° C. for 3 hours using a hot-air type dryer.

[Production of Resin-Impregnated Sheet Laminate with. Metal Foil]

On an aramid cushioning material (thickness of 3 mm, manufactured by Ichikawa Techno-Fabrics Co., Ltd.), a SUS304 sheet (thickness of 5 mm), a copper foil (“3EC-VLP”, thickness of 18 μm, manufactured by MITSUI MINING & SMELTING CO., LTD.), a resin-impregnated sheet laminate after subjecting to a heat treatment, a copper foil (“3EC-VLP”, thickness of 18 μm, manufactured by MITSUI MINING & SMELTING CO., LTD.), a SUS304 sheet (thickness of 5 mm) and an aramid cushioning material (thickness of 3 mm, manufactured by Ichikawa Techno-Fabrics Co., Ltd.) were laid in this order, followed by regular pressing at 340° C. under 5 MPa for 30 minutes using a high temperature vacuum press (“KVHC-PRESS” measuring 300 mm in length and 300 mm in width, manufactured by KITAGAWA SEIKI CO., LTD.) to obtain a resin-impregnated sheet laminate with a metal foil. Soldering-heat resistance after moisture absorption of this resin-impregnated sheet laminate with a metal foil was evaluated. The results are shown in Table 1.

TABLE 1

| | | | | | | Soldering heat | |
|---|---|---|---|---|---|---|---|
| | | | | | | resistance after | |
| | | | Resin- | | | moisture absorption | |
| | | | impregnated | | | | Measling |
| | | | sheet | Preliminary | | Delamination | is |
| | Drying | | Weight loss | pressing | | is observed | observed |
| | Temperature | Time | rate | Temperature | Time | Number/ | Number/ |
| Examples | (° C.) | Minutes | (% by mass) | (° C.) | (h) | Number | Number |
| Example 1 | 150 | 70 | 6.8 | 170 | 1 | 0/9 | 0/9 |
| Example 2 | 150 | 65 | 7.5 | 150 | 1 | 0/9 | 0/9 |
| Example 3 | 150 | 35 | 9.5 | 130 | 1 | 0/9 | 0/9 |
| Comparative | 150 | 80 | 6.1 | 170 | 1 | 6/9 | 0/9 |
| Example 1 | | | | 180 | 3 | 3/9 | 9/9 |
| Comparative | 150 | 75 | 6.4 | 170 | 1 | 4/9 | 0/9 |
| Example 2 | | | | 180 | 1 | 1/9 | 9/9 |
| Comparative | 150 | 20 | 12.1 | — | — | — | — |
| Example 3 | | | | | | | |

1. A resin-impregnated sheet obtained by impregnating a fiber sheet with a thermoplastic resin, wherein a weight loss rate upon a heat treatment at 225° C. for 30 minutes is from 6.8 to 10% by mass.

2. The resin-impregnated sheet according to claim 1, wherein the thermoplastic resin is a liquid crystal polyester.

3. The resin-impregnated sheet according to claim 2, wherein the liquid crystal polyester is a liquid crystal polyester including a repeating unit represented by the following formula (1), a repeating unit represented by the following formula (2) and a repeating unit represented by the following formula (3):
—O—Ar¹—CO—, (1)
—CO—Ar²—CO—, (2)
—X—Ar³—Y—, (3)
wherein Ar¹ represents a phenylene group, a naphthylene group or a biphenylylene group, Ar² and Ar³ each independently represents a phenylene group, a naphthylene group, a biphenylylene group, or a group represented by the following formula (4), X and Y each independently represents an oxygen atom or an imino group, and hydrogen atoms existing in the group represented by Ar¹, Ar² or Ar³ each independently may be substituted with a halogen atom, an alkyl group or an aryl group, and
—Ar⁴—Z—Ar⁵— (4)
wherein Ar4 and Ar5 each independently represents a phenylene group or a naphthylene group, and Z represents an oxygen atom, a sulfur atom, a carbonyl group, a sulfonyl group or an alkylidene group.

4. The resin-impregnated sheet according to claim 3, wherein the liquid crystal polyester is a liquid crystal polyester including 30 to 80 mol % of a repeating unit represented by the formula (1), 10 to 35 mol % of a repeating unit represented by the formula (2) and 10 to 35 mol % of a repeating unit represented by the formula (3), based on the total amount of all repeating units constituting the liquid crystal polyester.

5. The resin-impregnated sheet according to claim 3, wherein X and/or Y is/are imino group(s).

6. The resin-impregnated sheet according to claim 1, which is obtained by impregnating the fiber sheet with a liquid composition containing a thermoplastic resin and a solvent, and then removing the solvent.

7. The resin-impregnated sheet according to claim 6, wherein the solvent is a solvent containing 50% by mass or more of an aprotic compound.

8. The resin-impregnated sheet according to claim 7, wherein the aprotic compound is an aprotic compound having no halogen atom.

9. The resin-impregnated sheet according to claim 7, wherein the aprotic compound is an amide.

10. The resin-impregnated sheet according to claim 6, wherein the content of the thermoplastic resin in the liquid composition is from 10 to 50% by mass based on the total amount of the thermoplastic resin and the solvent.

11. A method for producing a resin-impregnated sheet laminate with a metal foil, which comprises preliminarily pressing a plurality of the resin-impregnated sheets according to claim 1, while being laid one upon another, subjecting the obtained resin-impregnated sheet laminate to a heat treatment, and arranging a metal foil on both sides of the sheet laminate, followed by regular pressing.
